(19) United States
(12) Patent Application Publication
(10) Pub. No.: US 2023/0104775 A1
(43) Pub. Date: Apr. 6, 2023

(54) HUMAN ROBOT COLLABORATION FOR FLEXIBLE AND ADAPTIVE ROBOT LEARNING

(71) Applicant: Hitachi, Ltd., Tokyo (JP)

(72) Inventors: Ravneet Kaur, San Jose, CA (US); Joydeep Acharya, Milpitas, CA (US); Sudhanshu Gaur, Cupertino, CA (US)

(73) Assignee: Hitachi, Ltd.

(21) Appl. No.: 17/493,652

(22) Filed: Oct. 4, 2021

(51) Int. Cl. G06N 20/00; G06T 7/00; G06K 9/00; B25J 9/16

(52) U.S. Cl. CPC G06N 20/00; G06T 7/0004; G06K 9/00335; G06K 9/00744; G06K 9/00765; B25J 9/163; G06T 2207/10016; G06K 2209/19

(57) ABSTRACT

Example implementations described herein involve systems and methods for training and managing machine learning models in an industrial setting. Specifically, by leveraging the similarity across certain production areas, example implementations can group together these areas to train models efficiently that use human pose data to predict human activities or specific task(s) the workers are engaged in. The example implementations do away with previous methods of independent model construction for each production area and takes advantage of the commonality amongst different environments.

### BACKGROUND

### Field

The present disclosure is generally directed to industrial systems, and more specifically, towards machine learning systems involving human robot collaboration.

### Related Art

In factories, industrial robots are programmed to perform a task such as welding, assembly, pick and place, and so on. However, there are many challenges associated with the industrial robots such as if a small change is required to the manufacturing line, then an integrator is often called to redesign and repurpose the robots to meet the new task specification. Furthermore, these robots are highly inflexible with respect to the robot programming interface, are often difficult to use, and require extensive programming knowledge which limits the ability of the line worker to easily repurpose the robot.

### SUMMARY

To overcome these challenges, human-robot collaboration in factories are on the rise, in which the robot needs to learn what the human does. Typically, the robot learning involves teaching a robot. Example implementations described herein involve a more adaptive and flexible technique in which the robot learns by observing human actions. In existing technologies, the human generally performs the task in a correct sequence for the robot to understand and learn, or use wearable sensors for more accurate sensor readings for human demonstration. Furthermore, these technologies use the quality of the product at the end of the task to compare with the robot task execution. However, in a manufacturing line, the quality information may not be available after each task is performed, which thereby requires an estimation of the quality of each task.

In example implementations described herein, there are systems and methods that record the human action as the human is performing the task and categorize these tasks into subtasks by observing the change point in the human actions and then estimate the quality of the subtasks based on the final product quality. Furthermore, the subtask sequence order is also determined, which is then sent to multiple robots performing the same task for robot learning.

Aspects of the present disclosure can involve a method, which can involve receiving information associated with a plurality of subtasks, the received information associated with human actions to train an associated robot in an edge system; conducting a quality evaluation on each of the plurality of subtasks; determining one or more subtask sequences from the plurality of subtasks; evaluating each of the one or more subtask sequences based on the quality evaluation of the each of the plurality of subtasks associated with the each of the one or more subtask sequences; and outputting ones of the one or more subtask sequences to train the associated robot based on the evaluation of the each of the one or more subtask sequences.

Aspects of the present disclosure can involve a computer program, which can involve instructions including receiving information associated with a plurality of subtasks, the received information associated with human actions to train an associated robot in an edge system; conducting a quality evaluation on each of the plurality of subtasks; determining one or more subtask sequences from the plurality of subtasks; evaluating each of the one or more subtask sequences based on the quality evaluation of the each of the plurality of subtasks associated with the each of the one or more subtask sequences; and outputting ones of the one or more subtask sequences to train the associated robot based on the evaluation of the each of the one or more subtask sequences. The computer program can be stored in a non-transitory computer readable medium and executed by one or more processors.

Aspects of the present disclosure can involve a system, which can involve means for receiving information associated with a plurality of subtasks, the received information associated with human actions to train an associated robot in an edge system; means for conducting a quality evaluation on each of the plurality of subtasks; means for determining one or more subtask sequences from the plurality of subtasks; means for evaluating each of the one or more subtask sequences based on the quality evaluation of the each of the plurality of subtasks associated with the each of the one or more subtask sequences; and means for outputting ones of the one or more subtask sequences to train the associated robot based on the evaluation of the each of the one or more subtask sequences.

Aspects of the present disclosure can involve an apparatus, which can involve a processor, configured to receive information associated with a plurality of subtasks, the received information associated with human actions to train an associated robot in an edge system; conduct a quality evaluation on each of the plurality of subtasks; determining one or more subtask sequences from the plurality of subtasks; evaluate each of the one or more subtask sequences based on the quality of the each of the plurality of subtasks associated with the each of the one or more subtask sequences; and output ones of the one or more subtask sequences to train the associated robot based on the evaluation of the each of the one or more subtask sequences.

Aspects of the present disclosure can involve an apparatus, which can involve one or more computer readable mediums storing instructions, and a processor that executes the instructions stored in the one or more computer readable mediums to perform the process involving receiving information associated with a plurality of subtasks, the received information associated with human actions to train an associated robot in an edge system; conducting a quality evaluation on each of the plurality of subtasks; determining one or more subtask sequences from the plurality of subtasks; evaluating each of the one or more subtask sequences based on the quality evaluation of the each of the plurality of subtasks associated with the each of the one or more subtask sequences; and output ones of the one or more subtask sequences to train the associated robot based on the evaluation of the each of the one or more subtask sequences.

### BRIEF DESCRIPTION OF DRAWING

FIGS. 1(a) and 1(b) illustrate two scenarios in a factory, in accordance with an example implementation.

FIG. 2 illustrates the overview of the architecture in accordance with an example implementation.

FIG. 3 illustrates a solution architecture involving a manufacturing system, in accordance with an example implementation.

FIG. 4 illustrates an example task information table sent from the ERP system to the task template acquisition module, in accordance with an example implementation.

FIG. 5 illustrates the flow diagram for the subtask learning module for human actions, in accordance with an example implementation.

FIG. 6 illustrates the flow diagram of the subtask learning module from, in accordance with an example implementation.

FIGS. 7(a) and 7(b) illustrates an example of the subtask identification step using a screwdriver example, in accordance with an example implementation.

FIG. 8 illustrates an example of the table that will be sent from the subtask learning module to the subtask evaluation module, in accordance with an example implementation.

FIG. 9 illustrates a flow diagram for the subtask evaluation module for analyzing the feature vector for each subtask, in accordance with an example implementation.

FIG. 10 illustrates an example for the probability distribution database from the subtask evaluation module, in accordance with an example implementation.

FIG. 11 illustrates examples of the tables that will be sent to the task reconstruction module, in accordance with an example implementation.

FIG. 12 illustrates an example of the task reconstruction module where for a given task ID and workcell type, multiple task sequences are generated and evaluated, in accordance with an example implementation.

FIG. 13(a) illustrates the communication between the edge video module and core video module, in accordance with an example implementation.

FIG. 13(b) illustrates an example of management information for task and workcell management, in accordance with an example implementation.

FIG. 14 illustrates the flow diagram for the robot learning system where the task reconstructed sequence is sent to the robot learning module through and the related subtask video clips are sent from the edge video module using the subtask video clip acquisition step, in accordance with an example implementation.

FIGS. 15(a) and 15(b) illustrate an example top and side view of the work product, in accordance with an example implementation.

FIG. 16 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In a factory, there is a well-defined task description template (i.e. Work Order) that details a sequence of tasks used to complete a product. A product is manufactured in a work cell. Each work cell has an assigned robot and human worker. Human workers can change over time or may not be present in the work cell with the robot.

In example implementations described herein, the robot downloads the task template for the specific product, observes the human tasks, learns subtasks, and takes product quality information as input.

In example implementations described herein, all robots in a factory feed this information to a central robot knowledge server along with their meta-data (e.g. for robot identifier (ID), human operator profile, product ID, and so on).

In example implementations, a global machine learning (ML) algorithm determines the correct subtasks for a given task by considering {subtask, quality} pairings over all inputs from all robots and feeds this information back to each robot that is doing the task.

In example implementations, the global algorithm determines an optimal order of subtasks which is then transmitted to each robot performing the task for robot learning.

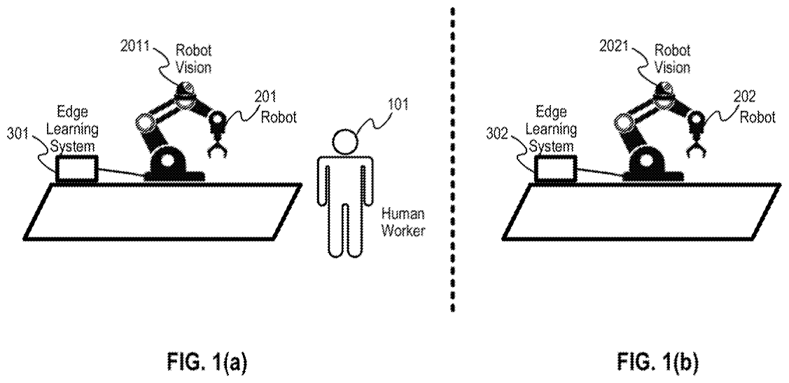

FIGS. 1(a) and 1(b) illustrate two scenarios in a factory, in accordance with an example implementation. Specifically, FIG. 1(a) illustrates an example in which the human worker 101 is working alongside the robot 201 which is connected to the edge learning system 301. The robot 201 is also equipped with a robot vision 2011 to observe the human worker. Similarly, in FIG. 1(b), the edge learning system 302 is connected to the robot 202 which is equipped with a robot vision 2021. However, in FIG. 1(b) the human is not present. To train a robot to perform a task, human actions are required.

In example implementations described herein, a core learning system is proposed that is connected to all the edge learning systems where the edge learning systems gathers the video data of the human actions performing a task, processes these actions into subtasks and send it to the core learning system for subtask evaluation and subtask sequence reconstruction. Thereon, the core learning system sends the updated subtask sequence for a task to the edge learning for robot to learn the task efficiently. Even in the case where no human is present at the work cell (i.e. the case in FIG. 1(b)), the core learning system sends the subtask sequence information and video to the edge learning system 302 which will enable robot to learn the skill of performing the task efficiently.

Although the example implementation described above involves robot vision 2011 or other camera or imaging devices installed in the robot 201 to observe the human worker, other systems can also be utilized to observe the human worker, and the present disclosure is not limited thereto. For example, the human worker can be observed by a separate camera and/or other imaging sensors (e.g., infrared sensors, depth cameras, etc.) that views the area in which the human worker is operating, or so on in accordance with the desired implementation.

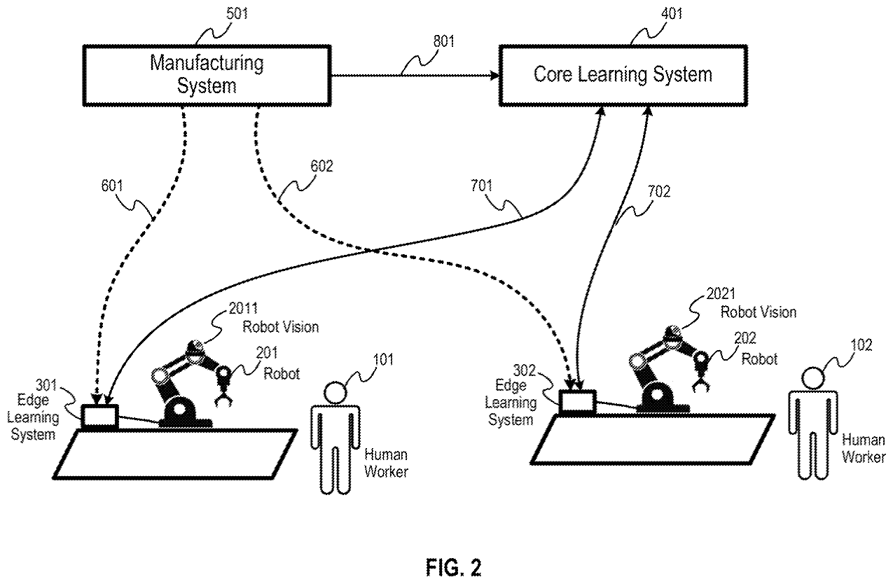

FIG. 2 illustrates the overview of the architecture in accordance with an example implementation. In example implementations, the manufacturing system 501 is connected to the edge learning system 301 and 302 and contains the quality information which is transported to the core learning system 401 through network connection 801. The manufacturing system 501 is also connected to the edge learning system 301 and 302 through network connections 601 and 602 where the manufacturing system provides information about the task to be performed for each robot 201 and human 101 collaboration in a work cell. Each of the two edge learning systems 301, 302, are connected to the robot 201, 202 respectively. Robot 201 is equipped with a robot vision 2011 and robot 202 is equipped with the robot vision 2021. The edge learning system 301, 302, are connected to the core learning system 401 through network connections 701 and 702 respectively, which acts as a central server that runs the machine learning models to divides the tasks into multiple subtasks, evaluate the subtask and prepare the best subtask sequence for robot learning.

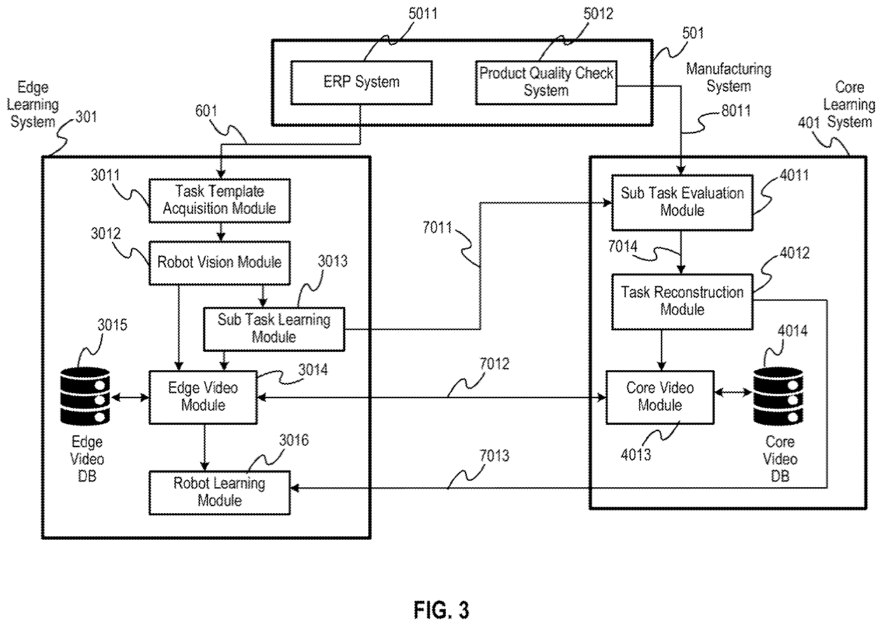

FIG. 3 illustrates a solution architecture involving a manufacturing system 501 that also involves an Enterprise Resource Planning (ERP) system 5011 and product quality check system 5012, in accordance with an example implementation. The ERP system 5011 is an integrated system that manages all aspects of production in a factory from generating the task schedule to maintaining financial records. The product quality check system 5012 keeps track of the quality of the product after the completion of the task(s). The ERP system 5011 and product quality check system 5012 in manufacturing system 501 is connected to the edge learning system 301 and the core learning system 401. These two systems are preferable because the edge learning system 301 is used for recording the video clips of the human actions for the task completion and identifying the respective subtasks. The core learning system 401 is used for evaluating the individual subtasks and reconstructing the correct subtask sequence for the robot learning. In the example implementation of FIG. 3, there can be one core learning system 401 and multiple edge learning systems 301 (e.g., one for each workcell with the robot). Thus, the core learning system 401 communicates with the other edge learning systems 301 and distributes the task sequence for robot learning for the same task or transmits single/multiple subtask(s) required for robot learning.

The edge learning system 301 is a system that articulates the task using task template acquisition module 3011 sent by the ERP system 5011, records the human actions from the robot vision using robot vision module 3012, divides the tasks into subtasks, and generates respective subtask videos using the subtask learning module 3013. These subtasks videos are stored in the edge video database (DB) 3015 using the edge video module 3014. Edge video module 3014 saves the current videos generated at the edge and updates the videos sent by the core learning system 401. The updated videos in the edge video module 3014 are then sent to the robot learning module 3016 for robot to start learning the subtask in a sequential manner in order to achieve higher accuracy in task completion.

The core leaning system 401 involves the subtask evaluation module 4011 which takes the subtask videos from the subtask learning module 3013 and the product quality check system 5012 and uses machine learning algorithms to predict the subtask quality. The estimated subtask quality is then sent to the task reconstruction module 4012 which uses the quality information and the frequency of the correct subtask sequence to evaluate the subtask sequences. The evaluated subtask sequence can be used to train the associated robot via the robot learning module 3016 as follows. The evaluation of the subtask sequence is used to select the subtask sequence. The subtask sequence is then sent to the core video module 4013 to request the respective videos from the edge video module 3014 and stores the subtask videos in the core video database (DB) 4014. The selected subtask sequence and the subtask videos can then be sent to the robot learning module 3016 over 7013.

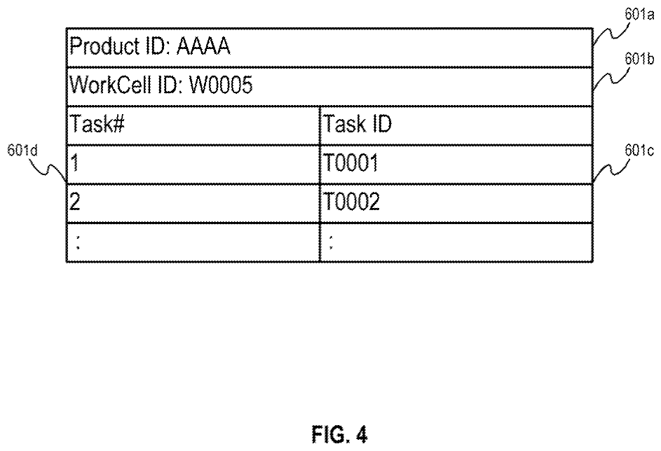

FIG. 4 illustrates an example task information table 601 sent from the ERP system 5011 to task template acquisition module 3011, in accordance with an example implementation. This table can involve the product identification (ID) 601a, workcell identification (ID) 601b and the task information such as task number 601d and task identification (ID) 601c. Task number 601d illustrates the schedule for the task to be completed by the workcell for one product and each task number is assigned with a task ID 601c. This table will be generated by the ERP system and the information of the task will be sent to each edge learning system 301, 302 (from FIG. 2).

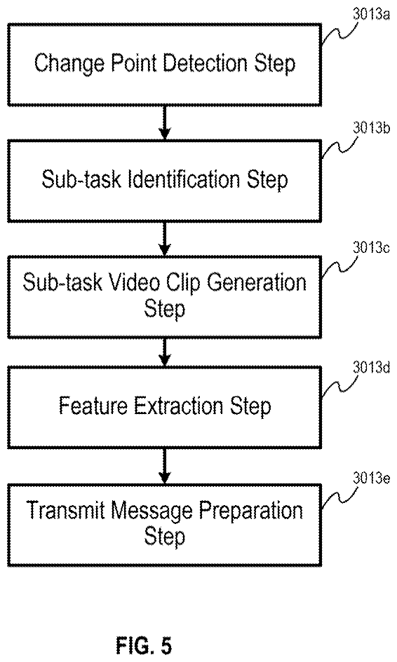

FIG. 5 illustrates the flow diagram for the subtask leaning module 3013 where the robot vision module 3012 records the human actions and sends the task video to the subtask learning module 3013, in accordance with an example implementation. The subtask leaning module 3013 involves a change point detection step 3013a in which the time periods are identified based on the significant change in the human action in the task video. Thereafter, for individual time periods, the subtasks are identified using the subtask identification step 3013b. Then, these subtasks and the respective time periods are used to generate video clips for each subtask using subtask video clip generation step 3013c. After the subtasks and the respective video clips are generated, the features are then extracted using feature extraction step 3013d from each video clip which are in the form of a feature vector. Then, the feature vector along with the meta data related to the task information (shown in FIG. 4) are transmitted to the core learning module 401 at step 3013e.

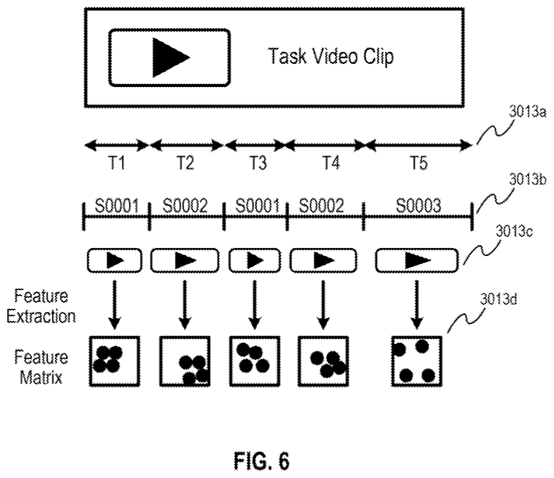

FIG. 6 illustrates the flow diagram of the subtask learning module 3013 where the task video clip from the robot vision module 3012 is divided into [T1, T5] based on the change points in the video clip and then the subtasks [S0001, 50002, 50001, 50002, 50003] are identified, in accordance with an example implementation. Using the time periods and the subtask ID, the video clips are generated for each subtask and the respective action features are extracted which are in the form of a feature vector. These action features are extracted from the video clips using techniques such as Two-Stream Inflated 3D ConvNet (I3D) which is based on the 2D ConvNet inflation that can seamlessly extract spatio-temporal features from videos. Other techniques may also be utilized in accordance with the desired implementation, and the present disclosure is not limited thereto.

These feature vectors along with the meta data about the task (such as task ID, worker cell ID, worker ID etc.) are transmitted to the core learning system 401. In the example of FIG. 6, the subtask IDs 50001 and 50002 are repetitive, however, the subtask 50003 appears to be a noise which needs to be removed. This removal will occur in the subtask identification step 3013b.

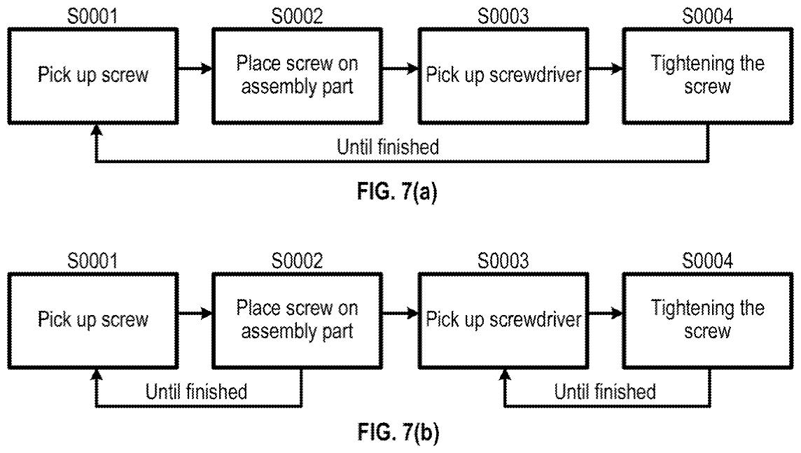

FIGS. 7(a) and 7(b) illustrates an example of the subtask identification step 3013a where an assembly part is assembled by using a screwdriver to screw multiple screwheads on the assembly part, in accordance with an example implementation. In this example, four different subtasks are identified as shown by 50001, 50002, 50003, and 50004. The two illustrations of FIGS. 7(a) and 7(b) shows the four common subtasks however, the sequence of the performance of these subtasks are different. In FIG. 7(a), the four subtasks are performed in a sequential manner to tighten one screw and thereafter, the next screw is tightened using the same order.

However, in FIG. 7(b), the same four subtasks are performed but not in the same order as FIG. 7(a). Here, all the screws are first picked up by the human and placed them on the assembly part followed by tightening via individual screw tightening. This example shows that the subtasks sequence for a given task ID may vary among different workers or same worker at different point in time.

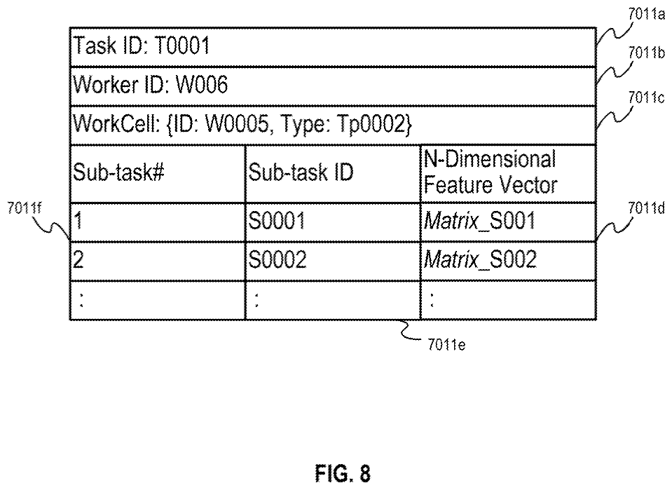

FIG. 8 illustrates an example of the table that will be sent from the subtask learning module 3013 to the subtask evaluation module 4011, in accordance with an example implementation. This table can involve the task meta data such as task ID 7011a, worker ID information 7011b, workcell ID and type 7011c that are received from the ERP system 5011 as described in FIG. 4. For example, the workcell type can indicate a workcell with no human being or a corner cell where the cell arrangement is different. The workcell ID with the same type can have the same order of the subtask sequence. Furthermore, the subtask sequence 7011f generated by the subtask learning module 3013 along with the subtask ID 7011e and respective feature vector 7011d can be included in this table.

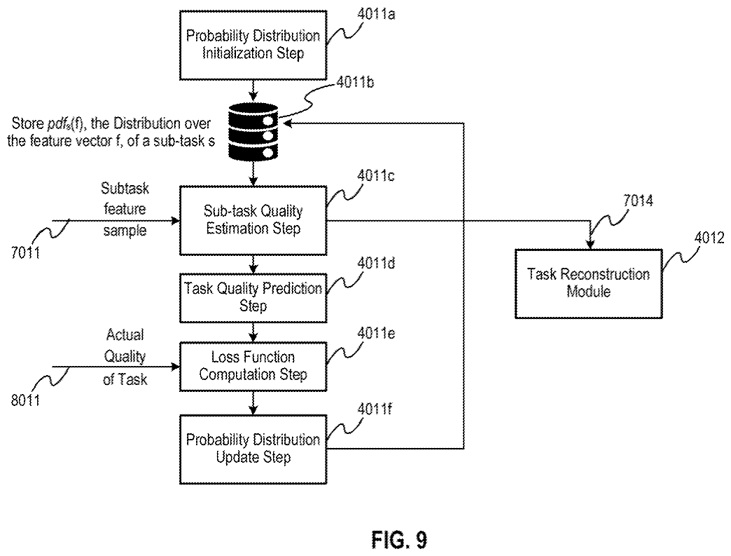

FIG. 9 illustrates a flow diagram for the subtask evaluation module 4011 where the feature vector for each subtask from the subtask learning module 3013 is analyzed to predict the subtask quality, in accordance with an example implementation. The first step is to initialize a probability distribution 4011a. Then, there is a database 4011b which is storing the distribution of a subtask over all its features. Meanwhile, if subtask feature sample 7011 transmits a new feature for evaluation, then by using the distribution, the subtask quality is estimated (i.e. generate a label for the subtask) using the subtask quality estimation step 4011c. Using the subtask quality 4011c, the final task quality is predicted 4011d and compared with the actual quality of the task 8011 acquired from the manufacturing system, the result of which is computed as loss function 4011e. Using this loss function, the probability distribution is updated 4011f and the subtask quality information is then sent to the task reconstruction module 4012. The steps involved in the subtask evaluation module 4011 are described below where subtask quality is estimated using a reinforcement learning technique.

To generate the quality evaluation/quality check of each of the subtasks, in a first step of the subtask evaluation module 4011, for each subtask STᵢ, fᵢ is used as the sampled feature vector for the respective subtask according to distribution Pᵢ [t]. In a second step, subtask evaluation module 4011 clusters the feature vector and apply a suitable threshold to learn binary function Ψᵢ that represent quality checkers after each subtask STᵢ. In a third step, the subtask evaluation module 4011 sets Ψᵢ(fᵢ)=qcᵢ.

To evaluate each of the one or more subtask sequences based on the quality evaluation of the each of the plurality of subtasks associated with the each of the one or more subtask sequences, in a fourth step, the subtask evaluation module 4011 uses these generated qcᵢs (quality check/evaluation for each subtask) to see the predictive ability in the final quality check for the task qc_{Final}. In a fifth step, the subtask evaluation module 4011 will construct a function that uses qc₁, qc₂, qc₃, . . . , qc_{(last subtask-1)} to predict qc_{Final}. In a sixth step, the subtask evaluation module 4011 obtains the actual quality check QC for the task from the product quality check system 5012. In a seventh step, the subtask evaluation module 4011 uses a validation dataset and generates a reward based on prediction of qc_{Final} compared with the actual quality check QC of the task. In an eighth step, the subtask evaluation module 4011 uses this reward to update the Pᵢ [t+1] based on Pᵢ [t] for each i. In a ninth step, the first through sixth steps are reiterated for as many training epochs as necessary. In a tenth step, based on Pᵢ [t_{final}], the subtask evaluation module 4011 assigns qcᵢ that are effective quality checks for each subtask STᵢ.

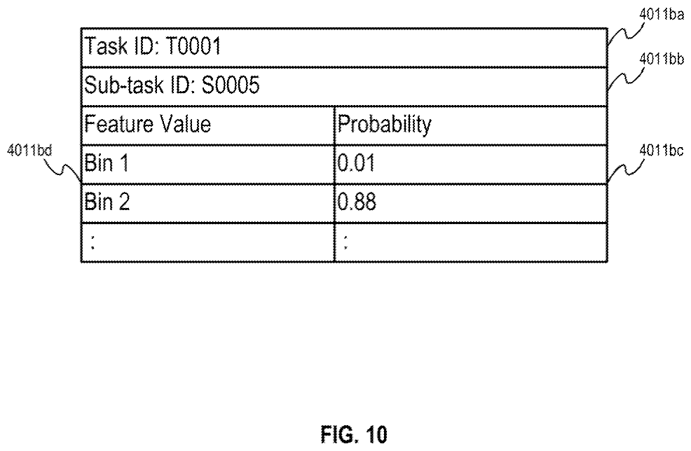

FIG. 10 illustrates an example for the probability distribution database 4011b from the subtask evaluation module 4011, in accordance with an example implementation. This database will involve the task ID 4011ba and the subtask ID 4011bb information along with the features 4011bd being used and its respective probability estimation 4011bc. The probability estimation 4011bc is indicative of which feature/bin will be more useful for the subtask selection.

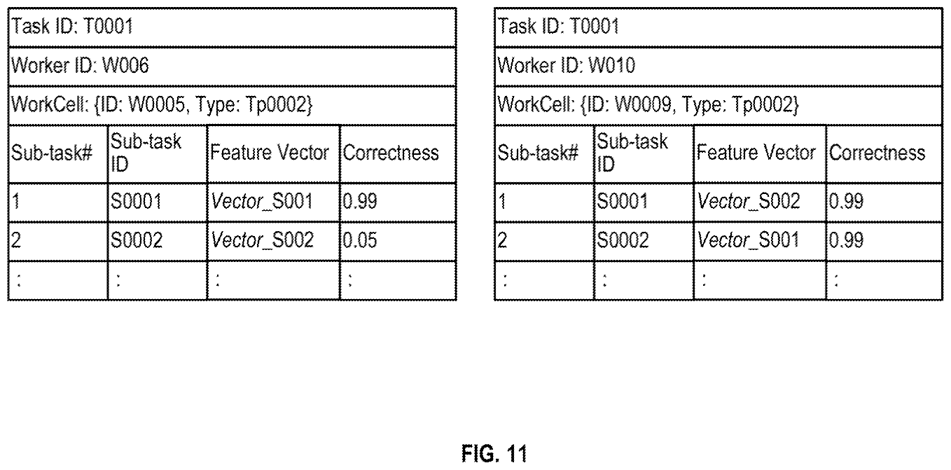

FIG. 11 illustrates examples of the tables that will be sent to the task reconstruction module 4012 via subtask quality transfer 7014, in accordance with an example implementation. These tables include information about the task ID, worker ID and workcell ID and Type. Furthermore, the table also involves the subtask ID and the respective feature vector information and the respective correctness measure that was evaluated by the subtask evaluation module 4011 through using the quality checks and the corresponding steps described with respect to FIG. 9. Here, two such tables are shown where the order of the sequence is different, and the correctness also varies with the different worker ID and the workcell ID. The multiple subtask ID columns are illustrated in FIG. 11 to show that there can be multiple sequences for a particular task (e.g., due to a task performance by different workers or from the same worker with different patterns for performing the task). Further, each sequence can also have multiple subtasks.

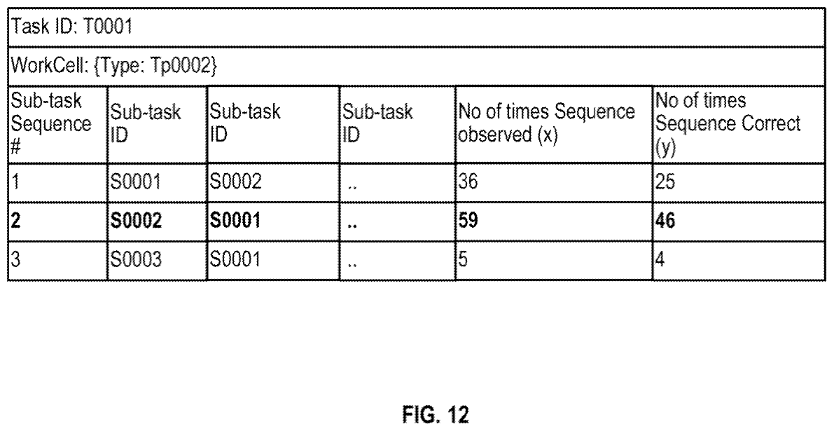

FIG. 12 illustrates an example of the table for task reconstruction module 4012 where for a given task ID and workcell type, multiple task sequences are generated and evaluated, in accordance with an example implementation. Specifically, FIG. 12 illustrates an example extension of FIG. 11, in which the tables illustrated in FIG. 11 are combined to showcase the correct sequence that is selected as will be demonstrated in equation (1) as follows. Out of all the task sequences, there will be many task sequences with all subtasks having higher correctness value. These higher correct subtask sequences are then used to identify the best sequence for the robot to learn and perform accuracy task. For example, here the total number of observations were n=100, where the first sequence was observed 36 times which was correct 25 times.

Similarly, the second sequence was observed 59 times, which was correct 46 times, and the third sequence was observed only five times, which was correct four times. In such case, the second sequence will be the suitable sequence for the robot to learn. This sequence has the maximum number of the correct sequences and occurred maximum number of times.

Thus, if x is the number of times the sequence was observed for n number of observations and y is the no. of times the sequence was correct. Then,

$$Correct Subtask Sequence = {arg min}_{i} \{ \frac{\vert {x}_{i} - {y}_{i} \vert}{n} : {x}_{i} > T ( n ) \} \qquad ( 1 )$$

$$\begin{matrix}where , i = 1 , 2 , 3 , … , k \\ T is a threshold \\ n is large sample set\end{matrix}$$

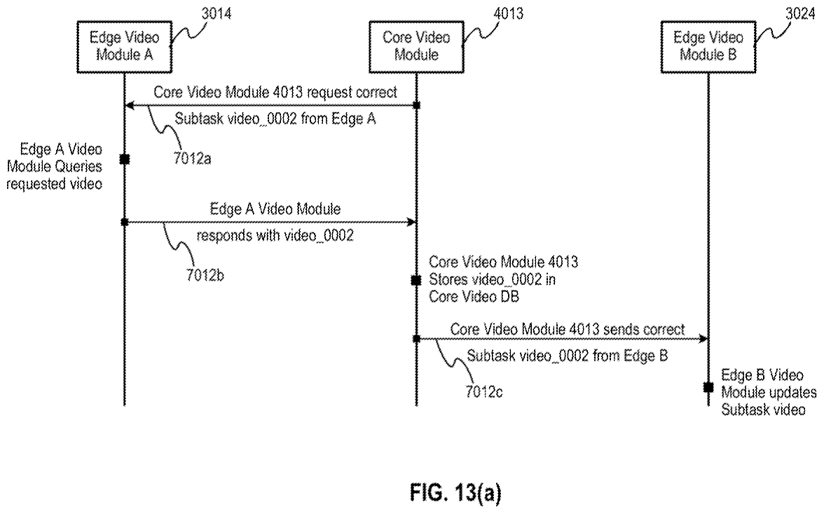

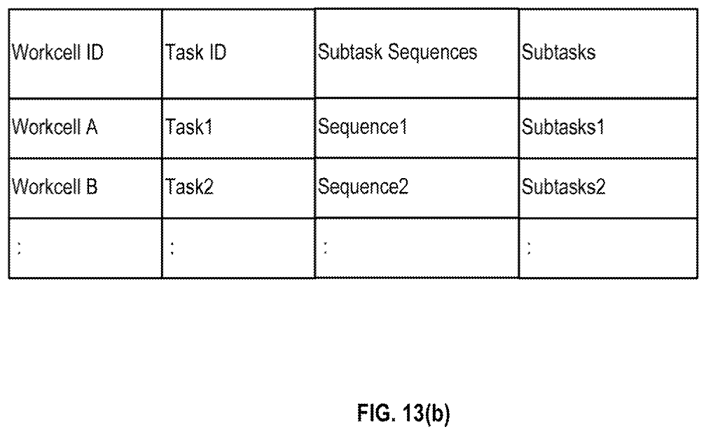

FIG. 13(a) illustrates the communication between the edge video modules 3014, 3024 and core video module 4013, in accordance with an example implementation. Here, the core video module 4013 acquired the correct sequence of subtask for the robot learning and now core video module requests (through 7012a) the edge video module A 3014 to send the required video. Then, the edge video module queries the requested video and sends the video (via 7012b) to the core video module 4013. Thereafter, the core video module 4013 stores the video in the core video database and sends that video to the edge video module B 3024 where the edge video module B 3024 updates the subtask video and stores in its database.

FIG. 13(b) illustrates an example of management information for task and workcell management, in accordance with an example implementation. The example management information can be managed in manufacturing system 501 and utilized by modules such as core video module 4013 as illustrated in FIG. 13(a) to share similar subtasks or tasks across workcells. If the task is the same across certain production areas then the management information can be used to track the production areas with the same task to facilitate the distribution of the reconstructed tasks across different edge learning systems. However if the tasks are not the same, but yet some of the subtasks are similar, then the other edge learning systems can request videos from the core learning system as illustrated in FIG. 13(a), from which the core video module 4013 can use the management information to distribute the corresponding videos. Management information can involve workcell ID, task ID, subtask sequences, and subtasks, but is not limited thereto and can omit or add additional information depending on the desired implementation. In this example, because workcell A and workcell B share a same subtask in the subtasks managed by the management information, the core video module 4013 can thereby reference module A to obtain the video of the subtask and forward the video to module B as illustrated in FIG. 13(a).

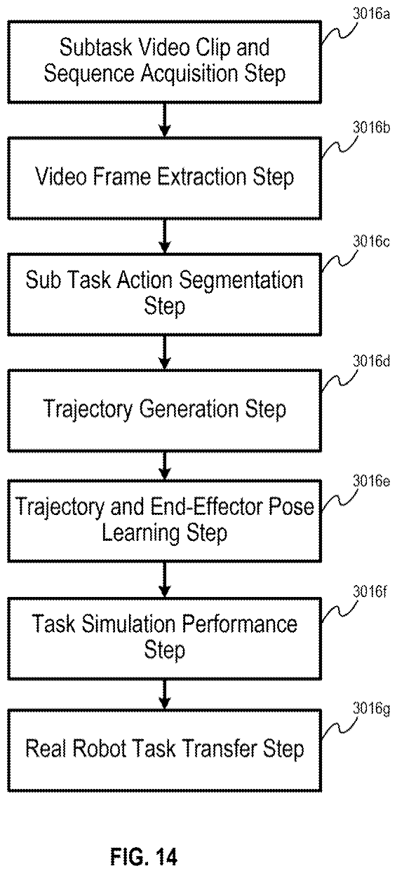

FIG. 14 illustrates the flow diagram for the robot learning system 3016 where the task reconstructed sequence is sent to the robot learning module 3016 through 7013 and the related subtask video clips are sent from the edge video module 3014 using the subtask video clip acquisition step 3016a, in accordance with an example implementation. Subtask video clips are used here to extract information for robot learning such as trajectory, human-object interaction, human pose, and other information in accordance with the desired implementation. Both the subtask video clips as well as the task reconstructed sequences are provided as the features extracted for robot learning and the subtask learning module may differ. The video clips are then used to extract the video frames using the video frame extraction step 3016b and each of these frames are processed to segment the actions using the subtask action segmentation step 3016c and these segmented video frames are also assigned a unique identifier that are associated with the task reconstructed sequence. From the segmented video frames for a subtask, the trajectory is generated at 3016d that will contain information about the set of connected waypoints (sequence of points or end-effector poses), trajectory parameters such as position, velocity and acceleration information etc. that are used for the robot manipulation. These trajectories will also involve information of the end effector that will be helpful for pick and place of the object. The trajectory and end-effector poses are then trained using the trajectory and end-effector pose learning step 3016e where techniques such as the Reinforcement Learning (RL) technique is used to train a robot to learn the subtask sequence from observation in order to perform the entire task. This trained model is then used in a simulation environment at 3016f to test the robot actions and then deploy into the real robot in the workcell using the real robot task transfer step 3016g. The framework used in this inversion is Robotic Operating System (ROS) where techniques such as the MoveIt package are used for motion planning, robot manipulation and control and the Gazebo simulator are used to test the robot action in simulation environment.

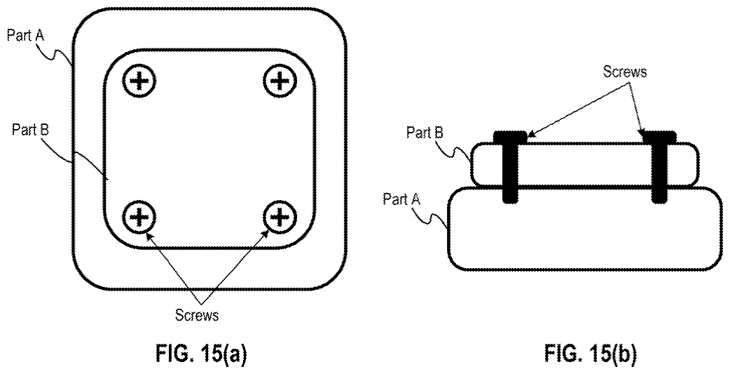

An example of a solution a solution description according to the example implementations is provided herein with respect to FIG. 3. A work order is created by the ERP system 5011 in manufacturing system 501. This work order contains information about the product to be manufactured and the work cell information. The example work order is part assembly (referring to FIGS. 15(a) and 15(b)) where the task is to attach part A to part B by using four screws. Thus, the task for the human is to place four screws on part B and tighten these screws using a screwdriver.

In the first step, the work order is first sent to the respective edge learning system 301 where the human and robot both are present in the workcell. In the second step, as the work order is received, the robot vision module 3012 will start recording the human performing task.

In a third step, after task video recording, the subtask learning module 3013 will process this video by looking into any significant changes in human actions in order to split the video into multiple subtask video. These subtasks identified by subtask learning module 3013 are
i. Pick up Part B from the workspace
ii. Place Part B on top of Part A
iii. Pick up screw 1 from workspace
iv. Place screw 1 on the part B
v. Pick up screwdriver from the workspace
vi. Tightening the screw 1 using the screwdriver
vii. Continue sub-steps iii-vi until all screws are tightened.

In the fourth step of the subtask learning module 3013, the subtasks identified in the third step and their respective video clips are then given a unique identifier (ID) and features are extracted from individual video clips using Convolutional Neural Network (CNN) based methods such as I3D. In example implementations, the CNN based methods can be replaced by other neural network based methods, such as, but not limited to, recurrent neural network (RNN) based methods, segment-based methods, multi-stream networks, and so on depending on the desired implementation, and the present disclosure is not limited to the CNN based methods. In a fifth step, the video clips are then stored in the edge video database (DB) 3015 through edge video module 3014. In a sixth step, the subtasks and their respective features from the fourth step are then sent to the subtask evaluation module 4011 in the core learning module 401. In a seventh step, the subtask evaluation module 4011 predicts the subtask quality which is then used to predict the task quality and then compares it with the actual quality of the task provided by the product quality check system 5012. The steps involved in the subtask evaluation are as follows.
i. Suppose there are four subtasks ST₁, ST₂, ST₃, ST₄
   For example,
      ST₁: Pick up screw
      ST₂: Place screw on Part B
      ST₃: Pick up screwdriver
      ST₄: Tighten the screw with screwdriver
   f₁, f₂, f₃, f₄ are the sampled feature vectors for the four subtasks STᵢ (where i=1,2,3,4) extracted in the fourth step from the video clips according to a distribution Pᵢ [t]
   For example,
      f₁: Distance (in pixels) from screw to the human hand
      f₂: Distance (in pixels) from screw to center of part B
      f₃: Distance (in pixels) from screwdriver to human hand
      f₄: Distance (in pixels) from screwdriver to the screwhead.
   Collect subtask data M times
      (f₁^{(j)}, f₂^{(j)}, f₃^{(j)}, f₄^{(j)})ⱼ₌₁^{M}
ii. Cluster these feature vectors using M data points and apply a suitable threshold to learn 4 binary functions Ψᵢ (i=1,2,3,4) that represent quality checkers after each subtask STᵢ. So, the output of each Ψᵢ is either 0 (outlier) or 1 (normal). Then for each j=1, . . . , M, estimate each subtask quality:
   Ψ₁(f₁^{(j)})=qc₁^{(j)}
   Ψ₂(f₂^{(j)})=qc₂^{(j)}
   Ψ₃(f₃^{(j)})=qc₃^{(j)}
   Ψ₄(f₄^{(j)})=qc₄^{(j)}
iii. Using qc₁^{(j)}, qc₂^{(j)}, qc₃^{(j)}, qc₄^{(j)} predict the qc_{Final}^{(j)}.
   For example, qc_{Final}^{(j)} could be just the product:
      qc_{Final}^{(j)}=qc₁^{(j)}·qc₂^{(j)}·qc₃^{(j)}·qc₄^{(j)}
iv. Get the actual QC^{(j)} for task T for j=1,2,3, . . . , M.
v. Collect M′ data points for validating the models. Generate a reward Rₗₑₐᵣₙ^{(j)} based on the prediction of qc_{Final}^{(j)} compared with the actual QC^{(j)}.
   If the reward is high, then the subtask quality check estimation is correct
   If the reward is low, then the quality check estimate is wrong
   For example: suppose qc₁^{(j)}=0, qc₂^{(j)}=1, qc₃^{(j)}=1, qc₄^{(j)}=1, so that the predicted qc_{Final}^{(j)}=0. This should lead to a lower reward if the actual task quality check QC^{(j)}=1
vi. Combine the individual rewards Rₗₑₐᵣₙ^{(j)} into a single reward Rₗₑₐᵣₙ for the entire validation set. Use Rₗₑₐᵣₙ to update the Pᵢ[t+1] based on Pᵢ[t] for each i=1,2,3,4.
   Thus, if Pᵢ[t] represents the probability distribution over the feature vectors for the i^{th} subtask at time t, then use Rₗₑₐᵣₙ to obtain a new distribution: Pᵢ[t+1]⇐ (Rₗₑₐᵣₙ, Pᵢ[t]).
vii. Apply steps i-vi as many training epochs as necessary
viii. Based on Pᵢ[t_{final}], assign qcᵢ that are effective quality checks for each subtask STᵢ

In an eight step, the subtask evaluation module 4011 will then produce a quality check for each of the subtasks and task reconfiguration module 4012 then selects the best sequence from the multiple correct subtask sequence using equation 1. An example for the different subtask sequence is shown in FIG. 7, and the best subtask sequence selection example is shown in FIG. 12.

In a ninth step, after selecting the best subtask sequence for a given task, the core video module 4013 requests the videos from the edge video module and sends the videos to the other edge learning module as shown in FIG. 13(a).

In a tenth step, the robot is ready to start learning the task using the video clips of the subtask sequence where the video frames are first extracted from the video clips and unique identifiers are given to each of the frame and the frames are segmented to identify the actions. Using the action frames for a subtask, the trajectory for that subtask is generated. Multiple trajectories are generated for a subtask and a model is trained that will be used for testing the robot actions in simulation. Thereafter, the learned and tested model is transferred to the real robot for real time task execution.

Example implementations involve a system for training and managing machine learning models in an industrial setting. Specifically, by leveraging the similarity across certain production areas, it is possible to group together these areas to train models efficiently that uses human pose data to predict human activities or specific task(s) the workers are engaged in. Specifically, the example implementations do away with previous methods of independent model construction for each production area and takes advantage of the commonality amongst different environments.

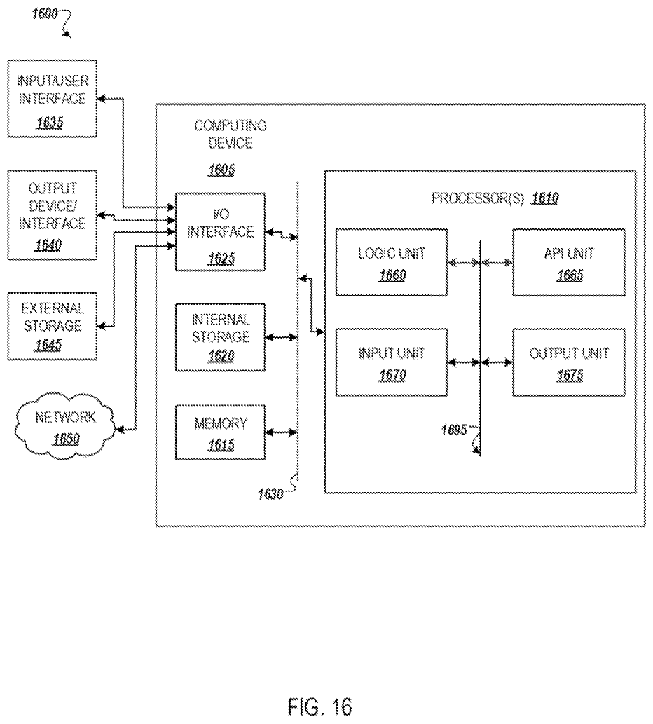

FIG. 16 illustrates an example computing environment with an example computer device suitable for use in some example implementations, such as to facilitate edge learning system 301, core learning system 401, or manufacturing system 501.

Computer device 1605 in computing environment 1600 can include one or more processing units, cores, or processors 1610, memory 1615 (e.g., RAM, ROM, and/or the like), internal storage 1620 (e.g., magnetic, optical, solid state storage, and/or organic), and/or I/O interface 1625, any of which can be coupled on a communication mechanism or bus 1630 for communicating information or embedded in the computer device 1605. I/O interface 1625 is also configured to receive images from cameras or provide images to projectors or displays, depending on the desired implementation.

Computer device 1605 can be communicatively coupled to input/user interface 1635 and output device/interface 1640. Either one or both of input/user interface 1635 and output device/interface 1640 can be a wired or wireless interface and can be detachable. Input/user interface 1635 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1640 may include a display, television, monitor, printer, speaker, braille, or the like. In some example implementations, input/user interface 1635 and output device/interface 1640 can be embedded with or physically coupled to the computer device 1605. In other example implementations, other computer devices may function as or provide the functions of input/user interface 1635 and output device/interface 1640 for a computer device 1605.

Examples of computer device 1605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1605 can be communicatively coupled (e.g., via I/O interface 1625) to external storage 1645 and network 1650 for communicating with any number of networked components, devices, and systems, including one or more computer devices of the same or different configuration. Computer device 1605 or any connected computer device can be functioning as, providing services of, or referred to as a server, client, thin server, general machine, special-purpose machine, or another label.

I/O interface 1625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1600. Network 1650 can be any network or combination of networks (e.g., the Internet, local area network, wide area network, a telephonic network, a cellular network, satellite network, and the like).

Computer device 1605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1605 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1610 can execute under any operating system (OS) (not shown), in a native or virtual environment. One or more applications can be deployed that include logic unit 1660, application programming interface (API) unit 1665, input unit 1670, output unit 1675, and inter-unit communication mechanism 1695 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1665, it may be communicated to one or more other units (e.g., logic unit 1660, input unit 1670, output unit 1675). In some instances, logic unit 1660 may be configured to control the information flow among the units and direct the services provided by API unit 1665, input unit 1670, output unit 1675, in some example implementations described above. For example, the flow of one or more processes or implementations may be controlled by logic unit 1660 alone or in conjunction with API unit 1665. The input unit 1670 may be configured to obtain input for the calculations described in the example implementations, and the output unit 1675 may be configured to provide output based on the calculations described in example implementations.

Processor(s) 1610 can be configured to receive information associated with a plurality of subtasks, the received information associated with human actions to train an associated robot in an edge system; conduct a quality evaluation on each of the plurality of subtasks; determine one or more subtask sequences from the plurality of subtasks; evaluate each of the one or more subtask sequences based on the quality evaluation of the each of the plurality of subtasks associated with the each of the one or more subtask sequences; and output ones of the one or more subtask sequences to train the associated robot based on the evaluation of the each of the one or more subtask sequences as illustrated in FIG. 3 and FIG. 9.

In example implementations, the information associated with the plurality of subtasks from the edge system associated with a robot can involve video clips, each of the video clips associated with a subtask from the plurality of subtasks; wherein the processor(s) 1610 is configured to output ones of the one or more subtask sequences to train the associated robot based on the evaluation of the each of the one or more subtask sequences by providing ones of the video clips associated with ones of the subtasks associated with the each of the one or more subtask sequences as illustrated in FIGS. 5 and 6.

In example implementations, the robot can involve robot vision configured to record video from which the video clips are generated; wherein a manufacturing system is configured to provide a task involving the plurality of subtasks to the edge system for execution and to provide a quality evaluation of the task for the evaluation of the each of the one or more subtask sequences as illustrated at 3012 and 5012 of FIG. 3 and FIG. 9.

Depending on the desired implementation, the video clips can involve the human actions of the plurality of subtasks as illustrated in FIGS. 2, 3, and 5. In an example implementation, the video clips can be recorded by a camera that is separate from the robot.

Processor(s) 1610 can be further configured to recognize each of the plurality of subtasks based on change point detection to the human actions as determined from feature extraction, wherein detected change points from the change point detection are utilized to separate the each of the plurality of subtasks by time period as illustrated in FIGS. 7(a) and 7(b).

Depending on the desired implementation, the edge system can be configured to identify the plurality of subtasks and provide the information associated with the plurality of subtasks based on the identification as illustrated at 3013 on FIGS. 3, 5, and 6.

In example implementations, processor(s) 1610 can conduct the evaluating the each of the one or more subtask sequences based on the quality evaluation of the each of the plurality of subtasks associated with the each of the one or more subtask sequences by constructing a function configured to provide a quality evaluation for the each of the one or more subtask sequences from the quality evaluation of the each of the plurality of subtasks associated with the each of the one or more subtask sequences; utilizing a validation set to evaluate the quality evaluation for the each of the one or more subtask sequences; modifying the function based on the evaluation of the quality evaluation for the each of the one or more subtask sequences based on reinforcement learning; iteratively repeating the constructing, utilizing, and modifying to finalize the function; and executing the finalized function to evaluate the each of the one or more subtask sequences as illustrated by the subtask evaluation module 4011, FIGS. 9 to 11, and the flow diagrams therein.

Processor(s) 1610 can also be configured to train the associated robot with the outputted evaluation, the training the associated robot involving selecting ones of the one or more subtask sequences based one the outputted evaluation and frequency of the each of the one or more subtask sequences; extracting video frames corresponding to each of the selected ones of the one or more subtask sequences; segmenting actions from the extracted video frames; determining trajectory and trajectory parameters for the associated robot from the segmented actions; and executing reinforcement learning on the associated robot based on the trajectory, the trajectory parameters, and the segmented actions to learn the selected ones of the one or more subtask sequences as illustrated by robot learning in FIGS. 11, 12, and 14.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
receiving information associated with a plurality of subtasks, the received information associated with human actions to train an associated robot in an edge system;
conducting a quality evaluation on each of the plurality of subtasks;
determining one or more subtask sequences from the plurality of subtasks;
evaluating each of the one or more subtask sequences based on the quality evaluation of the each of the plurality of subtasks associated with the each of the one or more subtask sequences; and
outputting ones of the one or more subtask sequences to train the associated robot based on the evaluation of the each of the one or more subtask sequences.

2. The method of claim 1, wherein the information associated with the human actions to train the associated robot in the edge system comprises video clips, each of the video clips associated with a subtask from the plurality of subtasks;
wherein the outputting the ones of the one or more subtask sequences to train the associated robot comprises providing ones of the video clips associated with ones of the subtasks associated with the each of the one or more subtask sequences.

3. The method of claim 2, wherein the robot comprises robot vision configured to record video from which the video clips are generated;
wherein a manufacturing system is configured to provide a task involving the plurality of subtasks to the edge system for execution and to provide a quality evaluation of the task for the evaluation of the each of the one or more subtask sequences.

4. The method of claim 2, wherein the video clips comprises the human actions of the plurality of subtasks.

5. The method of claim 4, further comprising recognizing each of the plurality of subtasks based on change point detection to the human actions as determined from feature extraction, wherein detected change points from the change point detection are utilized to separate the each of the plurality of subtasks by time period.

6. The method of claim 2, wherein the video clips are recorded by a camera that is separate from the robot.

7. The method of claim 1, wherein the evaluating the each of the one or more subtask sequences based on the quality evaluation of the each of the plurality of subtasks associated with the each of the one or more subtask sequences comprises:
constructing a function configured to provide a quality evaluation for the each of the one or more subtask sequences from the quality evaluation of the each of the plurality of subtasks associated with the each of the one or more subtask sequences;
utilizing a validation set to evaluate the quality evaluation for the each of the one or more subtask sequences;
modifying the function based on the evaluation of the quality evaluation for the each of the one or more subtask sequences based on reinforcement learning;
iteratively repeating the constructing, utilizing, and modifying to finalize the function; and
executing the finalized function to evaluate the each of the one or more subtask sequences.

8. The method of claim 1, wherein the using the evaluation of the each of the one or more subtask sequences to train the associated robot comprises:
selecting ones of the one or more subtask sequences based one the outputted evaluation and frequency of the each of the one or more subtask sequences;
extracting video frames corresponding to each of the selected ones of the one or more subtask sequences;
segmenting actions from the extracted video frames;
determining trajectory and trajectory parameters for the associated robot from the segmented actions; and
executing reinforcement learning on the associated robot based on the trajectory, the trajectory parameters, and the segmented actions to learn the selected ones of the one or more subtask sequences.

9. A non-transitory computer readable medium, storing instructions for executing a process comprising:
receiving information associated with a plurality of subtasks, the received information associated with human actions to train an associated robot in an edge system;
conducting a quality evaluation on each of the plurality of subtasks;
determining one or more subtask sequences from the plurality of subtasks;
evaluating each of the one or more subtask sequences based on the quality evaluation of the each of the plurality of subtasks associated with the each of the one or more subtask sequences; and
outputting ones of the one or more subtask sequences to train the associated robot based on the evaluation of the each of the one or more subtask sequences.

10. The non-transitory computer readable medium of claim 9, wherein the information associated with the human actions to train the associated robot in the edge system comprises video clips, each of the video clips associated with a subtask from the plurality of subtasks;
wherein the outputting the ones of the one or more subtask sequences to train the associated robot comprises providing ones of the video clips associated with ones of the subtasks associated with the each of the one or more subtask sequences.

11. The non-transitory computer readable medium of claim 10, wherein the robot comprises robot vision configured to record video from which the video clips are generated;
wherein a manufacturing system is configured to provide a task involving the plurality of subtasks to the edge system for execution and to provide a quality evaluation of the task for the evaluation of the each of the one or more subtask sequences.

12. The non-transitory computer readable medium of claim 10, wherein the video clips comprises the human actions of the plurality of subtasks.

13. The non-transitory computer readable medium of claim 12, the instructions further comprising recognizing each of the plurality of subtasks based on change point detection to the human actions as determined from feature extraction, wherein detected change points from the change point detection are utilized to separate the each of the plurality of subtasks by time period.

14. The non-transitory computer readable medium of claim 10, wherein the video clips are recorded by a camera that is separate from the robot.

15. The non-transitory computer readable medium of claim 9, wherein the evaluating the each of the one or more subtask sequences based on the quality evaluation of the each of the plurality of subtasks associated with the each of the one or more subtask sequences comprises:
constructing a function configured to provide a quality evaluation for the each of the one or more subtask sequences from the quality evaluation of the each of the plurality of subtasks associated with the each of the one or more subtask sequences;
utilizing a validation set to evaluate the quality evaluation for the each of the one or more subtask sequences;
modifying the function based on the evaluation of the quality evaluation for the each of the one or more subtask sequences based on reinforcement learning;
iteratively repeating the constructing, utilizing, and modifying to finalize the function; and
executing the finalized function to evaluate the each of the one or more subtask sequences.

16. The non-transitory computer readable medium of claim 9, wherein the using the evaluation of the each of the one or more subtask sequences to train the associated robot comprises:
selecting ones of the one or more subtask sequences based one the outputted evaluation and frequency of the each of the one or more subtask sequences;
extracting video frames corresponding to each of the selected ones of the one or more subtask sequences;
segmenting actions from the extracted video frames;
determining trajectory and trajectory parameters for the associated robot from the segmented actions; and

17. executing reinforcement learning on the associated robot based on the trajectory, the trajectory parameters, and the segmented actions to learn the selected ones of the one or more subtask sequences. An apparatus, comprising:
a processor, configured to:
receive information associated with a plurality of subtasks, the received information associated with human actions to train an associated robot in an edge system;
conduct a quality evaluation on each of the plurality of subtasks;
determine one or more subtask sequences from the plurality of subtasks;
evaluate each of the one or more subtask sequences based on the quality evaluation of the each of the plurality of subtasks associated with the each of the one or more subtask sequences; and
output ones of the one or more subtask sequences to train the associated robot based on the evaluation of the each of the one or more subtask sequences.
